(19) United States
(12) Patent Application Publication
(10) Pub. No.: US 2022/0262237 A1
(43) Pub. Date: Aug. 18, 2022

(54) SYSTEM AND METHOD FOR TRACKING TARGETS OF INTEREST

(71) Applicant: StarChase, LLC, Virginia Beach, VA (US)

(72) Inventors: Trevor A. Fischbach, Virginia Beach, VA (US); Amanda D. McCall, Virginia Beach, VA (US); Walter P. Olkowski, III, Virginia Beach, VA (US); John A. Sweet, New Milford, CT (US)

(21) Appl. No.: 17/672,308

(22) Filed: Feb. 15, 2022

Related U.S. Application Data
(60) Provisional application No. 63/149,482, filed on Feb. 15, 2021.

(51) Int. Cl. G08G 1/017; G08G 1/056; G08G 1/01; G08G 1/07; G06K 19/077; G06K 19/07; G06V 20/54; G05D 1/12; G05D 1/10; B64C 39/02

(52) U.S. Cl. CPC G08G 1/017; G08G 1/056; G08G 1/0125; G08G 1/0145; G08G 1/07; G06K 19/07758; B64C 2201/12; G06V 20/54; G05D 1/12; G05D 1/101; B64C 39/024; G06V 2201/07; G06K 19/0723

(57) ABSTRACT

A system and method for collecting and transmitting target data. In some embodiments, the method includes identifying a target of interest and tagging them with a tracking tag. Information about the target of interest may be collected from the tracking tag and stored in a collection module. The method further includes transmitting the collected information from the collection module to a central processing module and processing the collected information in combination with a set of reference data. The processed information may be monitored to identify one or more actionable events, and each actionable event and associated information may be relayed to an appropriate responder.

### RELATED APPLICATIONS

This application is related to U.S. Provisional Application No. 63/149,482, filed Feb. 15, 2021 and incorporated herein by reference in its entirety. This application is also related to U.S. Provisional Application No. 62/968,295 filed Jan. 31, 2020, the entirety of which is incorporated herein by reference.

### BACKGROUND

Asset tagging systems may be employed for various purposes. For example, asset tags may be used for tracking commercial vehicles of interest such as cargo motor vehicles and vessels to optimize the supply chain and reduce expenses. In the supply chain, asset tagging technology can enable seamless real-time updates to consumers regarding expected delivery times and trajectories, while simultaneously giving logistics coordinators real-time information to maximize efficiencies and schedule subsequent movements.

In other embodiments, asset tagging systems may also be used to avert risk-inducing high-speed pursuit of criminals; for example, see U.S. Pat. Nos. 6,246,323, 6,650,283, 8,436,730 and 10,269,262, the disclosures of which are incorporated by reference in their entireties.

However, there remains an opportunity for further optimization of asset tagging systems, including but not limited to criminal incident response, vehicular pursuit management, covert operations, drug trafficking enforcement and impaired driving enforcement, among others. This is especially true as more and more city infrastructure becomes integrated with so called “smart cities” and other similar technology, thereby enabling integration of and communication between different systems, and facilitation of automated or even artificial intelligence systems to manipulate different systems in real time to achieve different goals.

### SUMMARY

To this end, the present disclosure is directed generally to a system and method for collecting and transmitting target data. In some embodiments, the method includes identifying a target of interest and tagging them with a tracking tag. Information about the target of interest may be collected from the tracking tag and stored in a collection module, and/or transmitted directly to a central processing module. The collected information may be processed, and in some embodiments, be processed along with a set of reference data. The processed information may be monitored to identify one or more actionable events, and each actionable event and associated information may be relayed to an appropriate responder. In other embodiments, the actionable event may include an automated response that does not require input from a live responder.

In some embodiments, the tracking tag may include a tag physically affixed to the target of interest, while in other embodiments the tracking tag may be a virtual tag. Physically affixed tags may include a radio-frequency identification device (RFID). Such RFID devices may be configured to provide information about a target of interest to one or more RFID sensors that may be strategically located in an area, and/or affixed to mobile platforms (e.g, a drone, other vehicles, etc.). RFID devices, and/or tracking tags generally, may be configured to collect and transmit information regarding the target of interest, including but not limited to location, speed, direction, environmental conditions, etc.

In some embodiments, a system and method for collecting and transmitting target data is disclosed, wherein the method includes identifying a target of interest, tagging the target of interest with a tracking tag, collecting information about the target of interest utilizing the tracking tag, transmitting the collected information to a central processing module, and processing the collected information and triggering an actionable event. The method may include providing commands to a smart city infrastructure, including systems for controlling traffic lights or other traffic control mechanisms. In so doing, the system and method may control the traffic lights or other traffic mechanisms in a manner to enable a target of interest to progress with reduced risk to other vehicles/pedestrians (e.g, by providing green lights along an anticipated route), or steering the target in a desired direction by providing, for example, a path of green lights in a desired direction. Automated systems, capable of processing collected information about the target in real time, may be utilized to trigger and/or control the actionable events. In other embodiments, real time information may be provided to first responders who then trigger certain actionable events based on the first responder's judgment.

The methods described herein may be used for tracking various targets of interest, such as motor vehicles and vessels, to collect geographic positional data, and to transmit such data to recipients such as first responders, local, state, federal government and military. These and other aspects will become apparent to those skilled in the art after a reading of the following description.

### BRIEF DESCRIPTION OF THE DRAWINGS

FIG. 1 is a diagram of an exemplary wireless node network according to one embodiment; and

FIG. 2 is a diagram of various wireless standards.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

One aspect of the present disclosure is directed to a method for collecting and transmitting target data. The method may include, in some embodiments, one or more of identifying a target of interest, tagging the target of interest with a tracking tag, collecting information about the target of interest utilizing the tracking tag and storing the collected information in a collection module, transmitting the collected information from the collection module to a central processing module, processing the collected information in combination with a set of reference data, and monitoring the processed information to identify one or more actionable events. The method may further include relaying each actionable event and associated information to an appropriate responder. A tagging event may be used to initiate collecting and transmitting target data.

In some embodiments, the tracking tag may be physically affixed to the target of interest. For example, the tracking tag may be deployed from a handheld launcher, an enforcement vehicle, or via stationary platform and adhered to the target of interest.

In certain other embodiments, a non-contact method of tagging may be utilized to track a target of interest, such as virtual tagging of the target of interest. In one embodiment, virtual tagging may be accomplished by tagging the target from an image or video, and tracking the vehicle virtually using one or more cameras. For example, a target of interest may be tagged by visual detection via cameras, including cameras mounted at intersections or along streets (for example) and/or cameras that may be affixed to autonomous or remote-controlled aircraft (e.g., drones).

Other embodiments may include a plurality of tagging methods, including both physical and virtual. Some tagging methods may indirectly track the target of interest; for example, sensors may be placed on objects, including but not limited to, telephone poles, other vehicles, etc. to track the target of interest without placing a tracking tag directly onto the target.

In some embodiments, the tracking tag may be a radio-frequency identification device (RFID). An RFID device may be included or otherwise affixed to a target of interest, and information about the target of interest may be collected from one or more RFID detectors. Such RFID detectors may be strategically placed in and around a location of interest (e.g., along a street, at intersections, near key checkpoints, etc.) to capture information about the target of interest. RFID detectors may also be installed on non-stationary platforms, including for example on a vehicle that can follow the target of interest, or an automated vehicle or drone, for example, that may follow the target of interest. In some embodiments, the one or more RFID detectors may be configured to be in operable communication with a central processing module that can gather information regarding the target of interest.

In some embodiments, location and environmental data may be collected and used to optimize an incident response and tracking of the target of interest. Examples of location and environmental data may include the geographic position and altitude of a target of interest, a target's past and present trajectory and acceleration, and environmental conditions surrounding the target of interest (weather, traffic, etc.). For instance, previous positions of a target at points A, B and C may indicate that the target's next position is likely at point D. Positional data may be gathered from physical and/or virtual tags, including the physical affixation of a GPS and RF enabled asset tag to a target of interest, the visual detection of a target of interest via camera, RFID systems, and/or other IoT enabled hardware in autonomous metropolitan areas.

For example, the tracking tag may be a location device for determining a target location that can be collected and transmitted as part of the collected information. Devices for collecting information from the tracking tags may communicate with the tracking tags directly (e.g., via the Internet), or within subnetworks that are ultimately linked. For example, real-time position data pertaining to the target of interest may be collected utilizing GPS or other means of tracking. For further discussion, refer to the following patents—see U.S. Pat. Nos. 6,246,323, 7,990,265, 6,650,283 and 8,436,730, each of which is incorporated by reference in their entirety. Location and position data may be determined directly from the target of interest with the tracking tag, but in some instances, can be determined from other sensors such as those installed on other objects (e.g., the location of a nearby sensor identifying the target of interest).

Incorporating both virtual and physical tagging may be useful for more complete tagging events to take place. For example, traffic cameras may be used in combination with autonomous vehicles (e.g., drones) for situations such as identifying and locating a vehicle, and/or tracking a vehicle of interest after an incident (e.g., traffic stop, etc.). A traffic camera, for example, may be configured to detect a particular license plate (e.g., corresponding to an asset of interest). Upon detection, the system may transmit a signal to commence tracking/monitoring. In a hypothetical scenario in which a vehicle's license plate is known, but its location has yet to be determined, a traffic camera within a system of traffic cameras may provide the primary tagging event information which the system may use to then begin coordinated tracking of the tagged vehicle. This event may include collecting license plate information, and cross-referencing with a database of targets of interest, for example. After detecting a match, the location of the vehicle may be ascertained in real time. Subsequently, if another traffic camera in the same vicinity detects the same vehicle, a hypothetical trajectory may be established. Given this information, various tagging methods may be further deployed to provide real-time information and optimize incident response. For example, a drone may be deployed to virtually tag the target and/or affix a tracking tag (e.g., a nose cone) onto the target of interest, and/or additional cameras may be utilized to continue tracking the target. Responders (e.g., law enforcement) may be dispatched as well, with the option of interceding immediately or keeping a distance and tracking the target until a safer time/location is available.

Machine detection of a target of interest, such as a vehicle carrying a missing person or contraband, may enable a sensor-actuator network to trigger a confirmation indicating the instantaneous location of the asset. With a network of traffic cameras, for example, this type of tag offers additional descriptive information and visual indicators for tracking the exact location of the target. This may include information beyond just location, including direction and speed, for example. Additionally, given multiple data points on a grid, additional attributes such as speed of the vehicle and anticipated routes, directions, etc. may also be determined, allowing for physical and/or virtual tagging of a target of interest. Such automated machine detections may enable events to be tracked historically and in real-time.

Such systems may also include a central processing module. The central processing module may be a single, central processing unit, or may be distributed across multiple processing units within the system. In either scenario, the central processing unit may be configured to aggregate data inputs provided by cameras, sensors, etc. (all of which may, for example, be stored in a collection module and distributed at scheduled intervals or upon certain triggering events) and generate data output that may be utilized, for example, by responders to assess and prioritize incidents, or may be acted upon by automated systems. The data output may be accessible to responders in any format desired, including for example via API links. For example, supervisors may receive the data and utilize the data output to best determine incident response options including but not limited to dispatching of key personnel, asset location and capabilities assessment. Data inputs may also include historical information, real-time information and/or a combination thereof. In some embodiments, the data output may be from individual data input streams, or the data output may be generated from multiple data inputs. Examples of data outputs may include weather and road conditions, incident response such as gunshot detection, past event patterns, application data collected via social media conversations and/or current traffic environment.

In some embodiments, predictive analytics may be performed on data inputs compiled with reference data, such as for example data from smart cities and other API integration formats. The data may be received from a server/system via verbal information or machine language (M2M). The data input may be processed using general or assisted machine learning configured to analyze complex trends within critical data from past similar targets of interest and/or present data. One example of a machine learning method for processing the collected information and/or reference data may be deep neural networks (DNNs). The collected data and/or reference data may be processed through the use of multi-layered (hierarchical) analysis to dissect abstract trends and model non-linear relationships. When combined with DNN or lower level assisted machine learning, which may be built upon past pursuit related predictive behaviors for example, the responding agencies receiving the processed information may move resources ahead of the event to achieve more successful outcomes and/or mitigating the criminal behaviors/outcomes.

In some embodiments, the processed information may be relayed to responders directly (e.g., as is the case with agency and governmental officials). Alternatively, the processed information may be relayed via preexisting and developing alert systems. For example, processed information may be relayed via Amber Alert systems; the Integrated Public Alert and Warning System infrastructure (IPWAS); the National Emergency Alert System (EAS); the National Public Warning System (a Federal Emergency Management Agency system); other governmental and private alert systems, and IoT enabled devices.

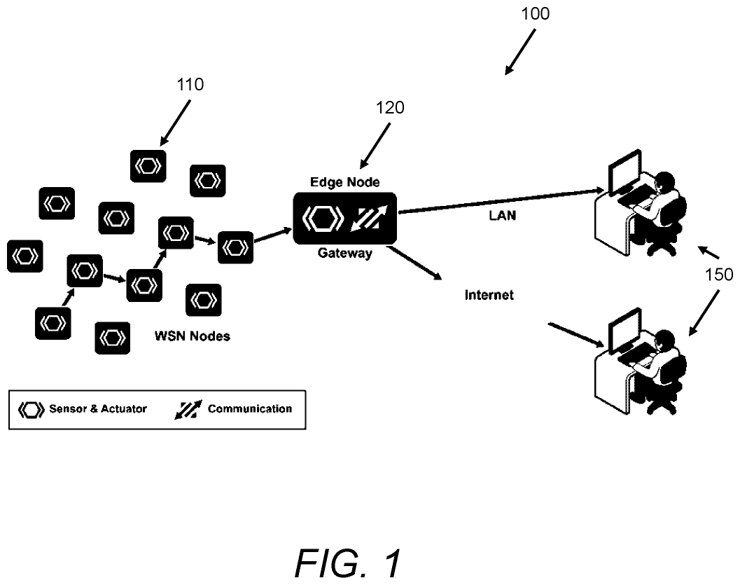

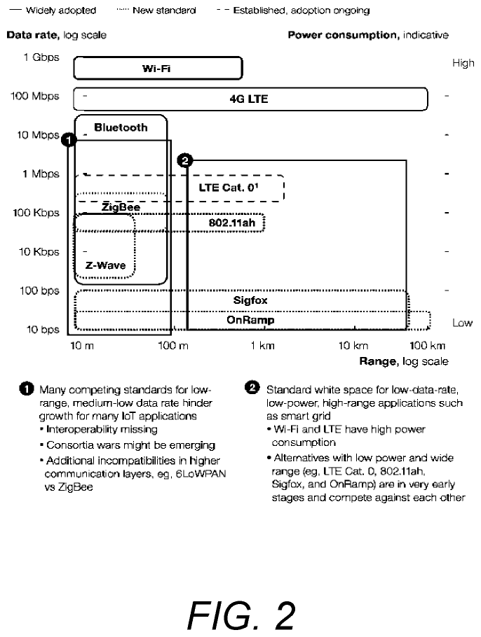

Referring now to FIG. 1, an exemplary system 100 according to some embodiments of the present disclosure is presented. As shown in FIG. 1, transmitting collected information and relaying processed information may be performed, for example, with networks of sensors 110 (for the collection of stimuli and data from surrounding environments), which may be paired with actuators for carrying out actions based on data collected by sensors. These networks may be Wireless Sensor and Actuator Networks (WSANs), which may perform specific actions contingent on thresholds from collected data, or simply transmit data collected by sensors, to external networks to be received, for example by human responders via the internet or other communication path, and/or distributed to other machine recipients (back end services) for automated processing and/or responses. In some examples, one or more of the sensors 110 may communicate with an edge node 120, which may then relay the information via internet or other network (e.g., LAN) to processing centers for presentation to first responders (e.g, first responders 150) or automated processing centers that may trigger automated or predetermined responses to different events or information received. In some embodiments, the processed data may be relayed to responders using various wireless means of communication including but not limited to 4G LTE, 5G, Mesh or local Networks, RFID and/or satellite. FIG. 2 provides a chart of gradient of data transmission rates (Y axis, also indicative of power consumption, on the Y₂ axis), superimposed with range of transmission for various wireless communication protocols. It will be further understood that the sensors 110 may also communicate directly with the edge node 120, or have sensed information relayed to edge node 120 via intervening sensors 110, as illustrated for example by the arrows in FIG. 1.

A networking protocol may be used for transmitting collected information such as location of a target and/or asset, velocity, acceleration, environmental conditions, and density of surrounding areas. In some examples, the collected information may be transmitted using radio frequencies. For instance, the radio frequency may be the IEEE 802.15.4 standard. The IEEE 802.15.4 standard may include any amendments to the standard, including but not limited to IEEE 802.15.4e and IEEE 802.15.4g. In some embodiments, edge nodes may be used for receiving a particular range of frequencies and transmitting signals from these actuators onto one or more networks (e.g., LAN, Internet). In some examples, smart city infrastructure may be employed to facilitate certain data transmissions, including for example transmitting information via edge nodes or other interface points to collect information and consolidate in one or more collection and/or processing modules, and actionable events determined and deployed as necessary throughout the system.

In some embodiments, the tracking tag may be a sensor for an IoT system, such as a Wireless Sensor Actuator Network Node (a “node”, which may also be visualized as 110 in FIG. 1). The sensor may be configured to perform functions such as measuring location, temperature and/or pressure, among other things. In some instances, the central processing module may be in proximity to the IoT equipment or customer's data via a local cloud or hybrid cloud. One example may be a Wireless Sensor Network (“WSN”) Edge network node (e.g., Edge Node 120), which is simply a node capable of Internet Protocol or other forms of high-speed connectivity. WSN edge nodes may enable devices within a smart city architecture, for example, to communicate with one another. Edge nodes may act as a gateway from a local network of sensors and actuators, providing access to internet and Local Area Network transmission and dissemination of messages. As seen in FIG. 1, a network of WSN sensors and actuators connected to one Internet Protocol Enabled Edge Node and configured to transmit collected information to the local area network and the internet.

Another example of a network for transmitting and/or relaying collected/processed information may be an IPv6 protocol in combination with 6LoWPAN (IPv6 over Low power Wireless Personal Area Networks), which enables compression of signals (‘headers’) received from nodes in sensor actuator networks, allowing for briefer transmission times.

In one illustrative example, consider an incident in which a target vehicle flees a traffic stop with law enforcement. Law enforcement may desire to pursue the vehicle, but doing so in a traditional manner (i.e., a high-speed pursuit) may be dangerous and undesirable. In some embodiments, the system disclosed herein could tag the vehicle (either physically with a physical tag deployed, for example, from the law enforcement vehicle), and/or virtually using traffic cameras or other sensors. In some embodiments, the physical and/or virtual tag may simply track the vehicle and provide updates as to the vehicle's location, speed, etc.

In some embodiments, however, the tagging information may be utilized by a user and/or an autonomous system in combination with smart city technology to help resolve the pursuit. For example, vehicle tagging data could be utilized to trigger certain traffic lights to advantageously mitigate risks to innocent bystanders, or even steer the target vehicle in a desired direction (e.g., out of a city center). In such embodiments, target vehicle data may be delivered to the central processing module via direct radio connection, the internet, via edge nodes, or the like, and a user and/or artificial intelligence system generate events in response to the data, such as for example giving the target vehicle green lights to minimize the risk of traffic accidents resulting from the target vehicle running a red light, and/or providing green lights along a desired route to encourage the target vehicle to follow a particular path (for example, a path to less populated area where the risk of a collision is reduced.

In certain other embodiments, upon indication that a target vehicle is fleeing, an alternative pursuit vehicle could be triggered and employed by the system, such as a drone. The drone could be configured to monitor the target vehicle from a safe distance, deliver a physical tracking tag to the vehicle, and/or implement other pursuit mitigation strategies (e.g., deploy spike strips ahead of the vehicle, electrically disable the vehicle, or the like).

In another example, target sensors (whether cameras, RFID devices, or the like) may be configured to monitor an area of interest for a target vehicle (e.g., a stolen vehicle or vehicle or target otherwise desired to be located and/or tracked). Upon detection, predetermined interventions could be automatically triggered, including for example continued monitoring of the vehicle location, route, speed, etc., dispatch of law enforcement to intercept the vehicle, deployment of a drone or other autonomous or driven vehicle for pursuing the target vehicle, or the like. Such systems could also similarly control smart city features such as traffic lights, gates, bridges, etc. to provide a clear path for the target vehicle and/or direct the target vehicle in a particular direction.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

1. A method for collecting and transmitting target data, the method comprising the steps of:
a) identifying a target of interest;
b) tagging the target of interest with a tracking tag;
c) collecting information about the target of interest utilizing the tracking tag;
d) transmitting the collected information to a central processing module;
e) processing the collected information in combination with a set of reference data, and monitoring the processed information to identify one or more actionable events; and
f) relaying each actionable event and associated information to an appropriate responder.

2. The method of claim 1, wherein the tracking tag is physically affixed to the target of interest.

3. The method of claim 2, wherein the tracking tag comprises a radio-frequency identification device (RFID).

4. The method of claim 3 wherein the information collected about the target of interest is collected from one or more RFID detectors in operable communication with the central processing module.

5. The method of claim 4 wherein the RFID detector comprises a drone configured to follow the target of interest.

6. The method of claim 2, wherein the tracking tag comprises a location device for determining a target location that can be collected and transmitted as part of the collected information.

7. The method of claim 1, wherein the tracking tag is virtual.

8. The method of claim 1 wherein the method further comprises the step of storing the collected information in a collection module, and transmitting the collected information from the collection module to the central processing module.

9. A method for collecting and transmitting target data, the method comprising the steps of:
a) identifying a target of interest;
b) tagging the target of interest with a tracking tag;
c) collecting information about the target of interest utilizing the tracking tag;
d) transmitting the collected information to a central processing module; and
e) processing the collected information and triggering an actionable event.

10. The method of claim 9, wherein the actionable event comprises commands to smart city infrastructure.

11. The method of claim 10 wherein the smart city infrastructure comprises systems for controlling traffic light signals.

12. The method of claim 11 wherein the actionable event comprises providing green lights to the target of interest along an anticipated route determined in real time from the collected information.

13. The method of claim 11 wherein the actionable event comprises controlling traffic signals in real-time based on the collected information to direct the target of interest along a desired route.

14. A system for collecting and transmitting target data, comprising a tag for deployment on a target of interest, wherein the tag transmits information about the target of interest to a central processing module, and further wherein the central processing module processes the information and identifies one or more actionable events.

15. The system of claim 14 wherein the one or more actionable events comprise commands to a smart city infrastructure.

16. The system of claim 15 wherein the smart city infrastructure includes mechanisms for controlling traffic signals in real time.
